(19) United States
(12) Patent Application Publication
(10) Pub. No.: US 2022/0407106 A1
(43) Pub. Date: Dec. 22, 2022

(54) GELLED ELECTROLYTE FOR LITHIUM-ION ELECTROCHEMICAL CELL

(71) Applicant: SAFT, Levallois-Perret (FR)

(72) Inventors: Julien DEMEAUX, BRUGES (FR); Marlène OSWALD, BLANQUEFORT (FR); Apoline GILOT, HECOURT (FR)

(73) Assignee: SAFT, Levallois-Perret (FR)

(21) Appl. No.: 17/771,287

(22) PCT Filed: Oct. 15, 2020
(86) PCT No.: PCT/EP2020/079087

§ 371 Date: Apr. 22, 2022

(30) Foreign Application Priority Data
Oct. 30, 2019 (FR) 1912192

(51) Int. Cl. H01M 10/0565; H01M 10/0525; H01M 4/505; H01M 4/485; H01M 4/58

(52) U.S. Cl. CPC H01M 10/0565; H01M 10/0525; H01M 4/505; H01M 4/485; H01M 4/58; H01M 2300/0085; H01M 2300/0082

(57) ABSTRACT

A gel-type electrolyte comprising a matrix which is a poly(vinylidene fluoride-co-hexafluoropropylene) polymer in which is embedded a liquid mixture comprising at least one lithium salt and a solvent comprising at least one linear carbonate, the poly(vinylidene fluoride-co-hexafluoropropylene) polymer matrix representing 5 to 95% by weight in relation to the weight of the gel-type electrolyte and the liquid mixture representing 95 to 5% by weight in relation to the weight of the gel-type electrolyte. This electrolyte exhibits increased stability with respect to oxidation and reduction.

### TECHNICAL FIELD

The technical field of the invention concerns electrolytes intended to be used in electrochemical cells of lithium-ion type, and more particularly electrochemical cells of lithium-ion type comprising an active cathodic material operating at high voltage, and an active anodic material containing a lithium titanium oxide or titanium oxide able to be lithiated.

### STATE OF THE ART

The term «electrochemical cell»and the term «cell»in the remainder hereof have the same meaning and are used equivalently. Electrochemical cells of lithium-ion type comprising an active cathodic material with high operating voltage, and an active anodic material containing lithium titanium oxide are known in the prior art. Mention can be made for example of document EP-B-2 945 211 which describes a cell comprising:
a cathode comprising an electrochemically active material containing LiMn_{1.5}Ni_{0.5}O₄;
an anode with Li₄Ti₅O₁₂ as electrochemically active material; and
a liquid electrolyte containing carbonates.

The use of a lithium titanium oxide in the anode of this type of cell is of interest since it allows charges and discharges to occur under strong currents. Charging under strong current of a lithium-ion cell comprising a graphite-based anode can lead to the formation of lithium dendrites at the anode. These dendrites can be responsible for the onset of internal short-circuiting. This is accounted for by the fact that diffusion of lithium in graphite is slow and if the current is too strong and the lithium does not intercalate itself sufficiently rapidly into the structure of the graphite, lithium metal is formed on the anode. This lithium deposit can progress into dendrites. The use of lithium titanium oxide instead of graphite overcomes the risk of onset of a lithium deposit on the anode. The use of lithium titanium oxide therefore allows improved safe use of the cell under a strong current.

This type of cell advantageously uses an active cathodic material with high operating voltage, typically of at least 4.5 V versus the Li⁺/Li couple. This high voltage allows partial offsetting of the voltage drop of the cell by about 1.5 V related to the fact that the potential of lithium titanium oxide is about 1.5 V versus the Li⁺/Li couple, whereas the potential of graphite is about 0.1 V versus the Li⁺/Li couple.

Despite the advantage of being able to be charged and discharged under strong current, this type of cell has the following disadvantages:
First, in the voltage range higher than 4.5 V versus the Li⁺/Li couple, oxidation is observed at the cathode of some compounds of the electrolyte solvent, in particular cyclic carbonates. In addition, when the electrolyte is subjected to a low voltage e.g. in the range of 1 to 1.5 V versus the Li⁺/Li couple, reducing of some electrolyte compounds is seen at the anode. For example, lithium salt reduces at the Li₄Ti₅O₁₂ anode to form fluorophosphates. Cyclic carbonates also reduce at the anode to form a passivation layer (SEI) thereat, but this layer is highly soluble for some charge states of the cell. It therefore no longer plays the role of anode protection. The succession of oxidation and reduction reactions of the electrolyte over cycling of the cell tends to degrade the electrolyte. The result is a drop in the cycling performance of the cell.
Secondly, manganese (II) contained in the LiMn_{1.5}Ni_{0.5}O₄ of the cathode is seen to migrate towards the anode with reducing thereof to manganese (0). The migration is also observed of titanium species contained in Li₄Ti₅O₁₂ of the anode towards the cathode. This cross-talk of chemical species between the anode and cathode leads to degradation of the anode and cathode and contributes towards further reducing the lifetime of the cell.

A cell of lithium-ion type is therefore sought having an electrolyte with increased stability against oxidation and reduction. An electrolyte is sought which is stable over the entire operating voltage range of an electrochemical cell comprising an active cathodic material having an operating voltage higher than or equal to 4.5 V versus the Li⁺/Li couple, and an active anodic material which is a lithium titanium oxide or titanium oxide able to be lithiated.

A cell of lithium-ion type is also sought which allows preventing migration of chemical species from one electrode to an electrode of opposite polarity.

Document U.S. Pat. No. 10,236,534 describes a lithium-ion cell comprising an anode containing Li₄Ti₅O₁₂, a cathode in material with high operating potential such as LiMn_{1.5}Ni_{0.5}O₄ and an electrolyte of gel type comprising a matrix formed from poly(ethylene oxide), or poly(vinylidene fluoride) PVDF, or polyacrylate, or poly(imidine). The preferred solvents are ethylene carbonate, diethyl carbonate and propylene carbonate. However, a poly(ethylene oxide), similar to a polyacrylate, contains oxygen atoms which can easily be reduced at low potential or oxidized at a high potential. This type of electrolyte is therefore not stable over the whole operating range of the cell.

Document WO 2017/196012 describes a lithium-ion cell comprising a polymer-based electrolyte with a main chain comprising vinylidene fluoride repeat units, and branched chains comprising sulfonate groups.

Document WO 2017/168330 describes a lithium-ion cell comprising an anode of which the active material can be Li₄Ti₅O₁₂ and a cathode of which the active material can be lithium manganese oxide LiMn₂O₄. The anode and cathode are separated by a polymer separator acting as solid electrolyte. This polymer is obtained by setting a mixture of a silicone-urethane prepolymer comprising polysiloxane and poly(ethylene oxide) units with the salt of lithium trifluoromethanesulfonimide LiN(CF₃SO₂)₂ (LiTFSI) dissolved in an ionic liquid i.e. butyl N-methylpyrrolidinium bis(trifluoromethylsulfonyl)imide (PYR₁₄TFSI). The objective of this document is to replace the lithium hexafluorophosphate salt LiPF₆ by lithium trifluoromethanesulfonimide LiN(CF₃SO₂)₂ (LiTFSI). The preferred solvent to improve contact between the electrodes and polymer separator is dimethyl carbonate (DMC).

Document US 2015/0004475 describes a lithium-ion cell having an anode containing a lithium titanium oxide such as LiTi₂O₄ and a cathode containing a high-voltage active material such as LiMn_{1.5}Ni_{0.5}O₄. The separator can be coated with a gel-type electrolyte composed of poly(ethylene oxide) or poly(vinylidene fluoride) or polyacrylonitrile.

Document US 2017/0288265 describes a gel-type electrolyte containing a poly(ethylene oxide) able to be used in a lithium-ion cell operating at high voltage. The solvent used in the fabrication of the electrolyte can be selected from among butylene carbonate, butyl sulfoxide, n-methyl-2-pyrrolidone, 1,2-diethoxyethane, ethyl methyl sulfone, triethylene glycol dimethyl ether, dimethyl tetraglycol, poly(ethylene glycol) dimethyl ether and γ-caprolactone.

### SUMMARY OF THE INVENTION

The invention proposes a gel-type electrolyte comprising a matrix which is a poly(vinylidene fluoride-co-hexafluoropropylene) (P(VdF-HFP)) polymer in which is embedded (or incorporated) a liquid mixture comprising at least one lithium salt and a solvent comprising at least one linear carbonate, the poly(vinylidene fluoride-co-hexafluoropropylene) polymer matrix representing 5 to 95% by weight relative to the weight of the gel-type electrolyte, and the liquid mixture representing 95 to 5% by weight relative to the weight of the gel-type electrolyte.

It has surprisingly been found that a gel-type electrolyte comprising a poly(vinylidene fluoride-co-hexafluoropropylene) matrix impregnated with a liquid mixture comprising a solvent comprising at least one linear carbonate is stable against oxidation at voltages higher than 4.5 V versus Li⁺/Li and also against reduction at voltages in the range of 1 to 1.5 V versus Li⁺/Li. The gel-type electrolyte of the invention allows an extended cycling lifetime of the cell.

It allows use of the cycled cell at a temperature ranging from ambient temperature to about 60° C. In addition, it offers the following advantages:
It solves the problem of leakages of liquid electrolyte which may occur in the event of opening of the casing of a cell having a liquid electrolyte. The invention therefore allows improved safety of use of the cell.
It allows reduced increase in impedance of the cell during cycling, hence reduced heating of the cell.
It allows reducing of the quantity of gases generated in the cell casing when the cell is being cycled.

In one embodiment, the poly(vinylidene fluoride-co-hexafluoropropylene) polymer matrix represents 5 to 25% by weight of the weight of the gel-type electrolyte.

In one embodiment, the solvent comprises ethyl methyl carbonate (EMC) and optionally another linear carbonate.

In one embodiment, the solvent comprises dimethyl carbonate (DMC) and optionally another linear carbonate.

In one embodiment, the solvent is composed solely of ethyl methyl carbonate (EMC) or is composed solely of dimethyl carbonate (DMC).

In one embodiment, the solvent comprises at least one cyclic carbonate and the proportion of said at least one cyclic carbonate is less than or equal to 10%, preferably less than or equal to 5% by volume relative to the volume of the solvent.

In one embodiment, the solvent does not comprise a cyclic carbonate.

In one embodiment, the solvent comprises at least one non-fluorinated linear carbonate and at least one fluorinated linear carbonate. Preferably, said at least one fluorinated linear carbonate does not represent more than 30% by volume of the linear carbonates, preferably no more than 10%.

In one embodiment, said at least one lithium salt is lithium hexafluorophosphate LiPF₆.

In one embodiment, the contribution of lithium ions made by LiPF₆ represents at least 90% of the total quantity of lithium ions of the electrolyte.

A further subject of the invention is an electrochemical cell comprising:
at least one cathode,
at least one anode,
the gel-type electrolyte such as described above.

In one embodiment, the cathode comprises an electrochemically active material able to operate at a voltage of at least 4.5 V versus the Li⁺/Li couple. It can be selected from the group composed of:
a compound from group i) of formula LiNiₓM_{y}Mn_{2-x-y}O₄ with 0<x≤1; 0≤y≤0.1 where M is at least one element selected from among Fe, Co and Al;
a compound from group ii) of formula LiMn₁₋ₓMₓPO₄ with 0≤x≤1 where M is at least one element selected from among Ni, Co, Fe and Al;
a compound from group iii) of formula LiNi₁₋ₓMₓPO₄ with 0≤x≤1 where M is at least one element selected from among Fe, Co, Mn and Al;
a compound from group iv) of formula LiCo₁₋ₓMₓPO₄ with 0≤x≤1 where M is at least one element selected from among Fe, Ni, Mn and Al;
a compound from group v) of formula LiₓM_{1-y-z-w}M′_{y}M″_{z}M′″_{w}O₂ where M, M′, M″ and M′″ are selected from the group composed of B, Mg, Al, Si, Ca, Ti, V, Cr, Mn, Fe, Co, Ni, Cu, Zn, Y, Zr, Nb, W and Mo provided that at least M or M′ or M″ or M′″ is selected from among Mn, Co, Ni or Fe; M, M′, M″ and M′″ differing from each other; and 0.8≤x≤1.4; 0≤y≤0.5; 0≤z≤0.5; 0≤w≤0.2 and x+y+z+w<2.1;
a compound from group vi) composed of the partially or fully disordered oxides and oxyfluorides of lithium and transition metals, of cubic structure, of formula Li₁₊ₓMO_{2-y}F_{y} where M is at least one element selected from the group composed of Na, K, Mg, Ca, B, Sc, Ti, V, Cr, Mn, Fe, Co, Ni, Cu, Zn, Al, Y, Zr, Nb, Mo, Ru, Ag, Sn, Sb, Ta, W, Bi, La, Pr, Eu, Nd and Sm and where 0≤x≤0.5 and 0≤y≤1; and
a mixture of several compounds selected from groups i) to vi).

In one embodiment, the anode comprises an electrochemically active material with an operating voltage of about 1.5 V versus the Li⁺/Li couple. It can be selected from the group composed of:
a compound from group a) of formula Liₓ₋ₐMₐTi_{y-b}M′_{b}O_{4-c-d}X_{c} where 0<x≤3; 1≤y≤2.5; 0≤a≤1; 0≤b≤1; 0≤c≤2 and −2.5≤d≤2.5;
   M is at least one element selected from the group composed of Na, K, Mg, Ca, B, Mn, Fe, Co, Cr, Ni, Al, Cu, Ag, Pr, Y and La;
   M′ is at least one element selected from the group composed of B, Mo, Mn, Ce, Sn, Zr, Si, W, V, Ta, Sb, Nb, Ru, Ag, Fe, Co, Ni, Zn, Al, Cr, La, Pr, Bi, Sc, Eu, Sm, Gd, Ti, Ce, Y and Eu;
   X is at least one element selected from the group composed of S, F, Cl and Br;
   such as Li_{4/3}Ti_{5/3}O₄ (Li₄Ti₅O₁₂), Li_{8/3}Ti_{4/3}O₄ (Li₂TiO₃), Li_{8/7}Ti_{12/7}O₄ (Li₂Ti₃O₇), LiTi₂O₄, LiₓTi₂O₄ with 0<x≤2 and Li_{4/7}Na_{4/7}Ti_{12/7}O₄ (Li₂Na ₂Ti₆O₁₄);
a compound from group b) of formula HₓTi_{y}O₄ where 0≤x≤1; 0<y≤2, such as H_{8/13}Ti_{24/13}O₄ (H₂Ti₆O₁₃), H_{8/25}Ti_{48/25}O₄ (H₂Ti₁₂O₂₅) and Ti₂O₄(TiO₂);
a compound from group c) of formula LiₓTi_{a-y}M_{y}Nb_{b-z}M′_{z}O_{((x+4a+5b)/2)-c-d}X_{c} where 0≤x≤5; 0≤y≤1; 0≤z≤2; 1≤a≤5; 1≤b≤25; 0.25≤a/b≤2; 0≤c≤2 and 0≤d ≤2; a−y>0; b−z>0;
   d is an oxygen vacancy;
   M and M′ are each at least one element selected from the group composed of Li, Na, K, Mg, Ca, B, Sc, Ti, V, Cr, Mn, Fe, Co, Ni, Cu, Zn, Al, Y, Zr, Nb, Mo, Ru, Ag, Sn, Sb, Ta, W, Bi, La, Pr, Eu, Nd and Sm;
   X is at least one element selected from the group composed of S, F, Cl and Br, such as TiNb₂O₇, Ti₂Nb₂O₉ and Ti₂Nb₁₀O₂₉;
   d) a mixture of several compounds selected from groups a) to c).

In one embodiment, the electrochemically active material of the cathode has the formula LiNiₓM_{y}Mn_{2-x-y}O₄ with 0<x≤1, 0≤y≤0.1 where M is at least one element from among Fe, Co and Al, the electrochemically active material of the anode has the formula Liₓ₋ₐMₐTi_{y-b}M′_{b}O_{4-c-d}X_{c} where 0.5≤x≤3; 1≤y≤2.5; a=0; b=0; c=0 and d=0; the liquid mixture comprises lithium hexafluorophosphate LiPF₆ and ethyl methyl carbonate (EMC) as solvent.

### DESCRIPTION OF THE FIGURES

FIG. 1 illustrates the variation in current passing through cells of type A, B and C under anodic sweep.

FIG. 2 illustrates the variation in voltage of cells of type D to G during formation with charge at C/10 followed by discharge at C/10, C being the nominal capacity of the cells.

FIG. 3 illustrates the variation in specific capacity of cells of type D to G when cycling at 45° C. as a function of the number of cycles performed.

FIG. 4 illustrates the variation in voltage of cells of type D, F and H during formation at 60° C. comprising charge at C/10 followed by discharge at C/10.

FIG. 5 illustrates the variation in specific capacity per gram of active cathodic material of cells D and H when cycling with a first series of 10 cycles performed at 60° C., followed by a second series of 22 cycles at 25° C.

FIG. 6 illustrates the variation in specific capacity per gram of active cathodic material of cells I and J when cycling at 25° C.

FIG. 7 gives the voltage variation curves of two cells of type J and K during formation at a temperature of 60° C.

FIG. 8 illustrates the variation in specific capacity per gram of active cathodic material of two cells of type J and K when cycling at 25° C.

FIG. 9 gives the voltage variation curves of cells of type L, M and N during formation at a temperature of 60° C.

FIG. 10 illustrates the variation in specific capacity per gram of active cathodic material of cells of type L, M and N when cycling with a first series of 40 cycles at 25° C., followed by second series of 20 cycles a 45° C., and a third series of 25 cycles at 60° C.

### DESCRIPTION OF EMBODIMENTS

The electrolyte of the invention is a gel-type electrolyte. It is obtained by mixing a poly(vinylidene fluoride-co-hexafluoropropylene) polymer (P(VdF-HFP) with a liquid mixture comprising at least one lithium salt and a solvent comprising at least one linear carbonate.

The poly(vinylidene fluoride-co-hexafluoropropylene) polymer (P(VdF-HFP) has the formula:

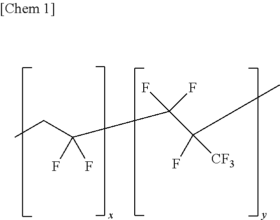

where x designates the number of repeat units of vinylidene fluoride and y designates the number of repeat units of hexafluoropropylene.

The weight average molecular weight of P(VdF-HFP) can vary from 300 Da to 5 MDa.

It can lie in the range of 300 to 800 Da or in the range of 200 to 400 kDa.
The p(VdF-HFP) matrix can represent 5 to 95% or 5 to 50%, or 5 to 20% or 5 to 10% by weight relative to the weight of the gel-type electrolyte. One preferred percentage range is the range of 5 to 25%, preferably ranging from 10 to 20%. This preferred range allows both the obtaining of good resistance of the electrolyte to oxidation at high cathode potentials and good reversible capacity of the cell. Resistance of the electrolyte to oxidation can decrease if the gel-type electrolyte contains 5% or less of polymer. The reversible capacity of the cell containing the electrolyte can decrease if the electrolyte contains a polymer percentage higher than 25%. In addition, for a polymer percentage higher than 25%, lesser impregnation is observed of the electrodes with the polymer. The polymer may be insufficiently in contact with the porosity of the electrodes.

Compared with PVdF, P(VdF-HFP) exhibits greater solubility with respect to the liquid mixture comprising said at least one lithium salt and the solvent.

The matrix may also comprise one or more polymers in association with p(VdF-HFP). This or these other polymers can be selected from among a poly(ethylene oxide), poly(vinylidene fluoride) PVDF, a polyacrylate and a poly(imidine). In this case, P(VdF-HFP) preferably represents at least 50% by weight of the mixture of polymers.

The gel allows preventing of cross-talk phenomena of chemical species between the anode and cathode. This cross-talk leads to degradation of the anode and cathode and to a reduced lifetime of the cell.

The liquid mixture comprises at least one lithium salt and a solvent comprising at least one linear carbonate. Said at least one linear carbonate can represent 95 to 5%, or 95 to 50%, or 95 to 80%, or 95 to 90% by weight relative to the weight of the gel-type electrolyte. Said at least one linear carbonate can be selected from the group composed of dimethyl carbonate (DMC), diethyl carbonate (DEC), ethyl methyl carbonate (EMC) and propyl methyl carbonate (PMC). Dimethyl carbonate (DMC) and ethyl methyl carbonate (EMC) are particularly preferred. The solvent may comprise EMC optionally with one or more other linear carbonates. The solvent may comprise EMC optionally in a mixture with DMC. The solvent can be free of linear carbonates other than EMC and DMC. The solvent may be solely composed of EMC or solely composed of DMC.

The solvent may comprise at least one non-fluorinated linear carbonate and at least one fluorinated linear carbonate. Preferably, said at least one fluorinated linear carbonate does not represent more than 30% of the volume of linear carbonates, preferably no more than 10%.

Said at least one linear carbonate can be used in association with one or more cyclic carbonates. However, cyclic carbonates are reactive towards the anode and cathode under operating conditions of the cell. This is why the solvent preferably comprises no more than 10 or no more than 5% by volume of said one or more cyclic carbonates. Over and above 10% of cyclic carbonate(s) loss of capacity of the cell can be observed. The following solvents can be envisaged:

EMC (99-90 vol. %)+EC (1-10 vol. %),

DMC (99-90 vol. %)+EC (1-10 vol. %),

the percentages being expressed relative to volume of solvent.

The solvent therefore preferably does not contain any cyclic carbonate.

Preferably, the solvent does not contain any linear ester(s) or cyclic ester(s) also called lactones. Linear esters tend to degrade in the presence of LiPF₆. The presence of lactones can have the effect of increasing irreversible capacity, leading to strong polarisation of the cell.

Preferably, the solvent does not contain any ethers.

The type of lithium salt is not particularly limited. Mention can be made of lithium hexafluorophosphate LiPF₆, lithium hexafluoroarsenate LiAsF₆, lithium hexafluoroantimonate LiSbF₆ and lithium tetrafluoroborate LiBF₄, lithium perchlorate LiClO₄, lithium trifluoromethanesulfonate LiCF₃SO₃, lithium bis(fluorosulfonyl)imide Li(FSO₂)₂N (LiFSI), lithium (trifluoromethanesulfonyl)imide LiN(CF₃SO₂)₂ (LiTFSI), lithium trifluoromethanesulfonemethide LiC(CF₃SO₂)₃ (LiTFSM), lithium bisperfluoroethylsulfonimide LiN(C₂F₅SO₂)₂ (LiBETI), lithium 4,5 -dicyano -2-(trifluoromethyl) imidazolide (LiTDI), lithium bis(oxalate)borate (LiBOB), lithium difluoro(oxalato) borate (LiDFOB), lithium tris(pentafluoroethyl)trifluorophosphate LiPF₃(CF₂CF₃)₃ (LiFAP) and mixtures thereof.

Preferably, said at least one lithium salt is lithium hexafluorophosphate LiPF₆. LiPF₆ can be associated with another lithium salt. However, the lithium ions derived from this other salt preferably represent at most about 10% of the total quantity of lithium ions contained in the gel-type electrolyte. This is particularly true if this other salt is LiBF₄. It has been observed that LiBF₄ has the effect of increasing the irreversible capacity of the cell, which is not desirable. It has also been observed that LiBF₄ causes a faster drop in cycling performance of the cell than when LiPF₆ is used as sole salt.

Preferably the gel-type electrolyte contains neither lithium bis(fluorosulfonyl)imide Li(FSO₂)₂N (LiFSI), nor lithium trifluoromethanesulfonimide LiN(CF₃SO₂)₂ (LiTFSI), nor lithium tetrafluoroborate LiBF₄, nor lithium bis(oxalate)borate (LiBOB), nor lithium difluoro(oxalato) borate (LiDFOB). Preferably the gel-type electrolyte does not contain a lithium salt other than lithium hexafluorophosphate LiPF₆.

One particularly preferred example of gel-type electrolyte of the invention comprises the matrix of poly(vinylidene fluoride-co-hexafluoropropylene) in which there is embedded a liquid mixture comprising LiPF₆ and a solvent formed of EMC, the matrix of poly(vinylidene fluoride-co-hexafluoropropylene) polymer representing 5 to 25% by weight relative to the weight of the gel-type electrolyte, the liquid mixture representing 95 to 75% by weight relative to the weight of the gel-type electrolyte. In this particularly preferred example, LiPF₆ is used as sole salt and the solvent is solely composed of EMC.

The concentration of said at least one lithium salt can range from 0.75 to 1.5 mol·L⁻¹. Preferably it ranges from 1 to 1.5 mol·L⁻¹. More preferably, it is about 1 mol·L⁻¹. It could be expected that a low concentration of lithium salt would allow an increase in fluidity of the gel-type electrolyte, would provide better soaking of pores with the active cathodic and anodic material and would improve the operation of the cell. Yet, surprisingly, it is possible to charge the cell with greater capacity when the lithium salt concentration is higher than or equal to 1 mol·L⁻¹ than when it is in the region of 0.7 mol·L⁻¹.

To fabricate the gel-type electrolyte, said at last one lithium salt is dissolved in the solvent. After dissolution of the salt, the poly(vinylidene fluoride-co-hexafluoropropylene) polymer is incorporated. The mixture is left under agitation for several minutes. It can be heated to a temperature not exceeding 50° C. to accelerate swelling of the polymer.

Preferably, the gel-type electrolyte is free of additive such as vinylene carbonate VC. Additives can be reactive, in which case there could occur cross-talk of the reaction products between the anode and cathode leading to degradation of the anode and cathode and to reduced lifetime of the cell.

### Active Anodic Material:

The active anodic material is characterized by an operating voltage of about 1.5 V versus the Li⁺/Li couple. The characteristic according to which the active anodic material has an operating voltage of about 1.5 V versus the potential of the Li⁺/Li electrochemical couple is an intrinsic characteristic of the active material. It can easily be measured with routine tests by those skilled in the art. For this purpose, skilled persons prepare an electrochemical cell comprising a first electrode composed of lithium metal and a second electrode comprising the active material for which it is desired to determine the potential relative to the Li⁺/Li electrochemical couple. These two electrodes are separated by a microporous membrane in polyolefin, typically a polyethylene, impregnated with electrolyte usually a mixture of ethylene carbonate and dimethyl carbonate in which LiPF₆ is dissolved at concentration of 1 mol·L⁻¹. Measurement of voltage is performed at 25° C. Negative active materials having an operating voltage of about 1.5 V versus the Li⁺/Li electrochemical couple are also described in the literature.

The active anodic material can be a lithium titanium oxide or titanium oxide able to be lithiated. It can be selected from the group composed of:
a compound from group a) of formula Liₓ₋ₐMₐTi_{y-b}M′_{b}O_{4-c-d}X_{c} where 0<x≤3; 1≤y≤2.5; 0≤a≤1; 0≤b≤1; 0≤c≤2 and −2.5≤d≤2.5;
   M is at least one element selected from the group composed of Na, K, Mg, Ca, B, Mn, Fe, Co, Cr, Ni, Al, Cu, Ag, Pr, Y and La;
   M′ is at least one element selected from the group composed of B, Mo, Mn, Ce, Sn, Zr, Si, W, V, Ta, Sb, Nb, Ru, Ag, Fe, Co, Ni, Zn, Al, Cr, La, Pr, Bi, Sc, Eu, Sm, Gd, Ti, Ce, Y and Eu;
   X is at least one element selected from the group composed of S, F, Cl and Br;
   This group a) compound includes the examples Li₄Ti₅O₁₂, Li₂TiO₃, Li₂Ti₃O₇, LiTi₂O₄, LiₓTi₂O₄ with 0<x≤2 and Li₂Na₂Ti₆O₁₄.
   Preferably 0.5≤x≤3;
   Preferably, a≤0.5;
   Preferably, b≤0.25;
   Preferably, c≤0.5;
   Preferably, a=0 and b=0 and c=0 and d=0.
a compound from group b) of formula HₓTi_{y}O₄ where 0≤x≤1; 0≤y≤2 such as H₂Ti₆O₁₃, H₂Ti₁₂O₂₅ and TiO₂;
a compound from group c) of formula LiₓTi_{a-y}M_{y}Nb_{b-z}M′_{z}O_{((x+4a+5b)/2)-c-d}X_{c} where 0≤x≤5; 0≤y≤1; 0≤z≤2; 1≤a≤5; 1≤b≤25; 0.25≤a/b≤2; 0≤c≤2 and 0≤d ≤2; a−y>0; b−z>0;
   d is an oxygen vacancy,
   M and M′ are each at least one element selected from the group composed of Li, Na, K, Mg, Ca, B, Sc, Ti, V, Cr, Mn, Fe, Co, Ni, Cu, Zn, Al, Y, Zr, Nb, Mo, Ru, Ag, Sn, Sb, Ta, W, Bi, La, Pr, Eu, Nd and Sm;
   X is at least one element selected from the group composed of S, F, Cl and Br.
   Preferably, M and M′ are selected from among Ti, V, Nb, Mo, Ta and W.
   Preferably, X is selected from among F and S.
   Preferably, d≤0.5.
   Preferably, M and M′ are selected from among Ti, V, Nb, Mo, Ta and W, and X from among F and S and d≤0.5.
   Examples of group c) compounds are TiNb₂O₇, Ti₂Nb₂O₉ and Ti₂Nb₁₀O₂₉.
   d) a mixture of several compounds selected from groups a) to c).
   The active anodic material is preferably at least one group a) compound or at least one group c) compound. In one embodiment, it comprises a mixture of at least one group a) compound with at least one group c) compound. This mixture can be Li₄Ti₅O₁₂ with TiNb₂O₇.

### Active Cathodic Material:

The electrochemically active cathodic material is preferably an active material operating at «high voltage», i.e. having an open circuit voltage of at least about 4.5 V versus the Li⁺/Li couple. Measurement of the voltage of the active cathodic material can be performed under the same conditions as those described for measurement of the operating voltage of the active anodic material.

The active cathodic material can be selected from the group composed of:
a compound from group i) of formula LiMn_{2-x-y}NiₓM_{y}O₄ with 0<x≤1; 0≤y≤0.1 where M is at least one element selected from among Fe, Co and Al;
a compound from group ii) of formula LiMn₁₋ₓMₓPO₄ with 0≤x≤1 where M is at least one element selected from among Ni, Co, Fe and Al;
a compound from group iii) of formula LiNi₁₋ₓMₓPO₄ with 0≤x≤1 where M is at least one element selected from among Fe, Co, Mn and Al;
a compound from group iv) of formula LiCo₁₋ₓMₓPO₄ with 0≤x≤1 where M is at least one element selected from among Fe, Ni, Mn and Al; and
a compound from group v) of formula LiₓM_{1-y-z-w}M′_{y}M″_{z}M′″_{w}O₂ where M, M′, M′ and M′″ are selected from the group composed of B, Mg, Al, Si, Ca, Ti, V, Cr, Mn, Fe, Co, Ni, Cu, Zn,

Y, Zr, Nb, W and Mo, provided that at least M or M′ or M″ or M′″ is selected from among Mn, Co, Ni, or Fe; M, M′, M″ and M′″ differing from each other; and 0.8≤x≤1.4; 0≤y≤0.5; 0≤z≤0.5; 0≤w≤0.2 and x+y+z+w<2.1;
a compound from group vi) composed of partially or fully disordered oxides and oxyfluorides of lithium and transition metals, of cubic structure, of formula Li₁₊ₓMO_{2-y}F_{y} where M is at least one element selected from the group composed of Na, K, Mg, Ca, B, Sc, Ti, V, Cr, Mn, Fe, Co, Ni, Cu, Zn, Al, Y, Zr, Nb, Mo, Ru, Ag, Sn, Sb, Ta, W, Bi, La, Pr, Eu, Nd and Sm and where 0≤x≤0.5 and 0≤y≤1;
a mixture vii) of several compounds selected from groups i) to vi).

The group i) compound can have the formula LiMn_{2-x-y}NiₓM_{y}O₄ with 0<x≤0.5; 0≤y ≤0.1 where M is at least one element selected from among Fe, Co and Al. Preferably, M is Al.

Preferably, 0≤y≤0.05. Examples of group i) compounds are LiMn_{1.5}Ni_{0.5}O₄ and LiMn_{1.55}Ni_{1.41}Al_{0.04}O₄.

The group ii) compound can have the formula LiMnPO₄.

The group iii) compound can have the formula LiNiPO₄.

The group iv) compound can have the formula LiCoPO₄.

The group v) compound can have the formula LiₓM_{1-y-z-w}M′_{y}M″_{z}M′″_{w}O₂, where 1≤x≤1.15; M is Ni; M′ is Mn; M″ is Co and M′″ is at least one element selected from the group composed of B, Mg, Al, Si, Ca, Ti, V, Cr, Fe, Cu, Zn, Y, Zr, Nb and Mo; 1−y−z−w>0; y>0; z >0; w≥0. An example of compound v) is LiNi_{1/3}Mn_{1/3}Co_{1/3}O₂.

The group v) compound can also have the formula LiₓM_{1-y-z-w}M′_{y}M″_{z}M′″_{w}O₂, where 1≤x≤1.15; M is Ni; M′ is Co; M″ is Al and M′″ is at least one element selected from the group composed of B, Mg, Si, Ca, Ti, V, Cr, Fe, Cu, Zn, Y, Zr, Nb and Mo; 1−y−z−w>0; y>0; z>0; w≥0. Preferably, x=1; 0.6≤1−y−z≤0.85; 0.10≤y≤0.25; 0.05≤z≤0.15 and w=0. One example of compound v) is LiNi_{0.8}Co_{0.15}Al_{0.05}O₂.

The group v) compound can also be selected from among LiNiO₂, LiCoO₂, LiMnO₂, Ni, Co and Mn possibly being substituted by one or more elements selected from the group composed of Mg, Mn (except for LiMnO₂), Al, B, Ti, V, Si, Cr, Fe, Cu, Zn and Zr.

The active cathodic material can be coated at least in part with a carbon layer.

The following associations of active cathodic material and active anodic material are preferred:
at least one group i) compound at the cathode and at least one group a) compound at the anode, for example LiMn_{1.5}Ni_{0.5}O₄ at the cathode and Li₄Ti₅O₁₂ at the anode;
at least one group i) compound at the cathode and at least one group c) compound at the anode, for example LiMn_{1.5}Ni_{0.5}O₄ at the cathode and TiNb₂O₇ at the anode, or LiMn_{1.55}Ni_{0.41}Al_{0.04}O₄ at the cathode and TiNb₂O₇ at the anode;
at least one group ii) compound at the cathode and at least one group a) compound at the anode, for example LiMnPO₄ at the cathode and Li₄Ti₅O₁₂ at the anode;
at least one group iv) compound at the cathode and at least one group a) compound at the anode, for example LiCoPO₄ at the cathode and Li₄Ti₅O₁₂ at the anode.

A group i) compound is advantageous compared with a group v) compound in that it releases two to three times less energy on thermal runaway of the cell.

### Cathode and Anode Binder:

The active cathodic and anodic materials of the lithium-ion electrochemical cell are generally mixed with one or more binders having the function of binding together the particles of active material and of bonding these to the current collector on which they are deposited.

The binder can be selected from among carboxymethylcellulose (CMC), a styrene-butadiene copolymer (SBR), polytetrafluoroethylene (PTFE), polyamide-imide (PAI), polyimide (PI), styrene-butadiene rubber (SBR), polyvinyl alcohol, polyvinylidene fluoride (PVDF) and a mixture thereof. These binders are typically used in the cathode and/or in the anode.

### Current Collector of the Cathode and Anode:

The current collector of the cathode and anode is in the form of a solid or perforated metal foil. The foil can be produced from different materials. Mention can be made of copper or copper alloys, aluminium or aluminium alloys, nickel or nickel alloys, steel and stainless-steel.

The current collector of the cathode is generally an aluminium foil or an alloy mostly containing aluminium. The current collector of the anode can be copper foil or an alloy mostly containing copper. It can also be an aluminium foil or an alloy mostly containing aluminium. At the operating voltage of the anode (about 1.5 V versus Li⁺/Li), it is effectively impossible to insert Li in the aluminium or to create a LiAl alloy. The thickness of the cathode foil can differ from that of the anode foil. The cathode or anode foil generally has a thickness of between 6 and 30 μm.

In one preferred embodiment, the aluminium collector of the cathode is coated with a conductive coating e.g. carbon black, graphite.

### Fabrication of the Anode:

The active anodic material is mixed with one or more above-cited binders and optionally a good electronic conducting compound such as carbon black. An ink is obtained that is deposited on one or both surfaces of the current collector. The ink-coated current collector is laminated to adjust the thickness thereof. In this manner an anode is obtained.

The composition of the ink deposited on the anode can be as follows:
75 to 96% of active anodic material, preferably 80 to 85%;
2 to 15% of binder(s), preferably 5%;
2 to 10% of electronic conducting compound, preferably 7.5%.

Fabrication of the Cathode:

The same procedure is followed as for the anode but starting from active cathodic material.

The composition of the ink deposited on the cathode can be as follows:
75 to 96% of active cathodic material, preferably 80 to 90%;
2 to 15% of binder(s), preferably 10%;
2 to 10% of carbon, preferably 10%.

### Separator:

A separator is generally inserted between an anode and cathode to prevent any short circuiting. The separator material can be selected from among the following materials: a polyolefin e.g. polypropylene PP, polyethylene PE, polyester, polymer-bound glass fibres, polyimide, polyamide, polyaramid, polyamide-imide and cellulose. Polyester can be selected from among polyethylene terephthalate (PET) and polybutylene terephthalate (PBT). Advantageously, the polyester or polypropylene or polyethylene contains or is coated with a material from the group composed of a metal oxide, carbide, nitride, boride, silicide and sulfide. This material can be SiO₂ or Al₂O₃. The separator can be coated with an organic coating, for example comprising an acrylate or PVDF or P(VdF-HFP).

One preferred separator is composed of polyethylene or is composed of the association of three layers i.e. polypropylene PP/polyethylene PE/polypropylene PP.

### Preparation of the Electrochemical Bundle:

In a first variant, the gel-type electrolyte is deposited in contact with the composition of active cathodic material. Next, a separator is deposited on the composition of active cathodic material impregnated with the gel-type electrolyte. The surface of the separator intended to be in contact with the composition of active anodic material is coated with the gel-type electrolyte. An anode is then positioned in contact with the gel-type electrolyte.

In a second variant, the gel-type electrolyte is deposited both on the composition of active cathodic material and on the composition of active anodic material. A separator is inserted between the composition of active cathodic material and the composition of active anodic material both impregnated with gel-type electrolyte.

In a third variant, the two surfaces of the separator are soaked with gel-type electrolyte and the separator is inserted between a cathode and an anode.

After these different variants, an assembly is obtained in which the gel-type electrolyte and the separator are sandwiched between an anode and a cathode. It can be noted that the presence of a separator is not necessary if the mass of P(VdF-HFP) represents at least 50% of the mass of the gel-type electrolyte, In this case, the gel-type electrolyte acts both as separator and as electrolyte.

Before initiating «formation»of the electrodes i.e. performing a first charge/discharge cycle of the cell, it can be useful to leave the cell to rest at a temperature higher than ambient temperature e.g. 50 or 60° C., for several hours e.g. 5 to 15 hours, to promote impregnating of the active material of the electrodes with the gel-type electrolyte.

### Formation of the Cell

Formation of the cell can be performed at temperature lower than or equal to 50° C., for example ranging from 20 to 50° C. An increase in formation temperature allows better soaking of the electrode pores with the gel-type electrolyte.

### EXAMPLES

Different types of lithium-ion cells referenced A to N were prepared. The constituents of these different types of cells are summarized in Table 1 below. In all the cells, the separator is a three-layer separator: Celgard® 2325 PP/PE/PP (PP: polypropylene; PE: polyethylene).

TABLE 1

| | | Solvent | Lithium | Electrolyte | Cathode | |
|---|---|---|---|---|---|---|
| Type | Electrolyte | (volume ratios) | salt | additive | (weight ratios) | Anode |
| A* | Liquid | EC:PC:EMC:DMC | LiPF₆ | VC (1 wt. %) | without active | Lithium |
| | | (10:20:25:45) | 1 mol.L⁻¹ | | material, Carbon + | metal |
| | | | | | PTFE (95:5) | |
| B | Gel: 10 wt % | EMC | LiPF₆ | — | without active | Lithium |
| | ofP(VdF- | | 1 mol.L⁻¹ | | material, Carbon + | metal |
| | HFP)** | | | | PTFE (95:5) | |
| C | Gel: 20 wt. % | EMC | LiPF₆ | — | without active | Lithium |
| | ofP(VdF- | | 1 mol.L⁻¹ | | material, Carbon + | metal |
| | HFP)** | | | | PTFE (95:5) | |
| D* | Liquid | EC:PC:EMC:DMC | LiPF₆ | VC (1 wt. %) | LiMn_{1.55}Ni_{0.41}Al_{0.04}O₄ | Li₄Ti₅O₁₂ |
| | | (10:20:25:45) | 1 mol.L⁻¹ | | | |
| E* | Liquid | EMC | LiPF₆ | — | LiMn_{1.55}Ni_{0.41}Al_{0.04}O₄ | Li₄Ti₅O₁₂ |
| | | | 1 mol.L⁻¹ | | | |
| F | Gel: 10 wt. % | EMC | LiPF₆ | — | LiMn_{1.55}Ni_{0.41}Al_{0.04}O₄ | Li₄Ti₅O₁₂ |
| | ofP(VdF- | | 1 mol.L⁻¹ | | | |
| | HFP)** | | | | | |
| G | Gel: 10 wt. % | EMC | LiPF₆ | — | LiMn_{1.55}Ni_{0.41}Al_{0.04}O₄ | Li₄Ti₅O₁₂ |
| | ofP(VdF- | | 1 mol.L⁻¹ | | | |
| | HFP)*** | | | | | |
| H | Gel: 20 wt. % | EMC | LiPF₆ | — | LiMn_{1.55}Ni_{0.41}Al_{0.04}O₄ | Li₄Ti₅O₁₂ |
| | ofP(VdF- | | 1 mol.L⁻¹ | | | |
| | HFP)** | | | | | |
| I* | Liquid | EC:PC:EMC:DMC | LiPF₆ | VC (1 wt. %) | LiMm_{1.50}Ni_{0.5}O₄ | Li₄Ti₅O₁₂ |
| | | (10:20:25:45) | 1 mol.L⁻¹ | | | |
| J | Gel: 20 wt. % | EMC | LiPF₆ | — | LiMm_{1.50}Ni_{0.5}O₄ | Li₄Ti₅O₁₂ |
| | of P(VdF- | | 1 mol.L⁻¹ | | | |
| | HFP)** | | | | | |
| K | Gel: 20 wt. | EMC | LiPF₆ | — | LiMm_{1.50}Ni_{0.5}O₄ | Li₄Ti₅O₁₂ |
| | % of P(VdF- | | 0.7 | | | |
| | HFP)** | | mol.L⁻¹ | | | |
| L | Gel: 10 wt. | EMC | LiPF₆ | — | LiMm_{1.50}Ni_{0.5}O₄ | Li₄Ti₅O₁₂ |
| | % of P(VdF- | | 1.2 | | | |
| | HFP)** | | mol.L⁻¹ | | | |
| M | Gel: 10 wt. | EC:EMC | LiPF₆ | — | LiMm_{1.50}Ni_{0.5}O₄ | Li₄Ti₅O₁₂ |
| | % of P(VdF- | (10:90) | 1.2 | | | |
| | HFP)** | | mol.L⁻¹ | | | |
| N | Gel: 10 wt. | EC:EMC | LiPF₆ | — | LiMm_{1.50}Ni_{0.5}O₄ | Li₄Ti₅O₁₂ |
| | % of P(VdF- | (30:70) | 1.2 | | | |
| | HFP)** | | mol.L⁻¹ | | | |

*outside the invention
**P(VdF-HFP) having a weight average molecular weight ranging from 500 to 600 Da.
***P(VdF-HFP) having a weight average molecular weight of about 300 kDa.

### a) Evaluation of Electrolyte Stability

Anodic sweep was performed on cells of type A, B and C described above. Each of these cells comprised:
a cathode comprising carbon (LiTX™ 200, Cabot) and PTFE deposited on an aluminium current collector;
an anode in lithium metal.

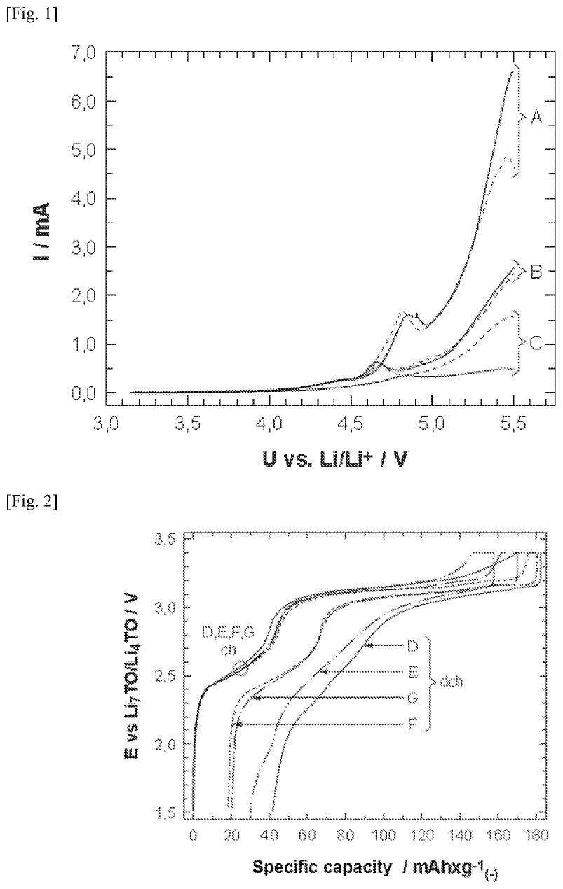

Two cells per type A, B and C were produced. The cathode of these cells was free of electrochemically active material so as only to evaluate the effect of a voltage increase on the stability of the electrolyte. The cells were previously subjected to an impregnation phase with the electrolyte at 60° C. for 6 hours. Anodic sweep was performed 60° C. at a rate of 0.1 mV·s⁻¹. The results are given in FIG. 1. This Figure shows a strong increase in current when the voltage exceeds 4.5 V vs. Li⁺/Li for type A cells comprising a liquid electrolyte containing cyclic carbonates (EC, PC). This indicates degradation of the electrolyte of type A cells via oxidation of the cyclic carbonates under the effect of a voltage increase. The current resulting from oxidation and reduction reactions of the electrolyte in cells of type B and C of the invention is weaker than that produced by the type A cells This demonstrates the advantage of jointly using a P(VdF-HFP) gel-type electrolyte and a solvent comprising at least one linear carbonate. Similarly, cathodic sweep was performed on cells of type A, B and C described above, each comprising:
a cathode comprising carbon (LiTX™ 200, Cabot) and PTFE deposited on a copper current collector;
an anode in lithium.

The results of this cathodic sweep show that by using the gel-type electrolyte of the invention, it is also possible to limit reduction of the electrolyte in the voltage range of 1 to 1.5 V versus Li⁺/Li.

To conclude, the gel-type electrolyte of the invention exhibits good stability against oxidation and reduction. It allows an increased cycling lifetime of the cell. Any drop in conductivity observed of the gel electrolyte compared with a liquid electrolyte is offset by the increase in stability provided by the association of poly(vinylidene fluoride-co-hexafluoropropylene) with the linear carbonate.

### b) Effect of the Electrolyte of the Invention on the Irreversible Capacity of Lithium-Ion Cells Comprising a High-Voltage Active Cathodic Material.

Cells comprising LiMn_{1.55}Ni_{0.41}Al_{0.04}O₄ as active cathodic material operating at high voltage were produced. These were cells of types D and G described in Table 1 above. They were subjected to an impregnation phase of the electrodes with the electrolyte for 12 hours at 60° C., the electrolyte being either in liquid form (cells D and E), or in gelled form containing P(VdF-HFP) (cells F and G). The cells were then subjected to formation consisting of C/10 charge followed by C/10 discharge, C being the nominal capacity of the cells. The charge/discharge curves are given in FIG. 2. This Figure shows that type F and G cells of the invention exhibit lower irreversible capacity than type D and E cells. Irreversible capacity is measured in FIG. 2 by calculating the difference between the charge capacity at the charging step and the discharge capacity at the following discharge step. It gives an indication of the quantity of lithium no longer taking part in the charge/discharge cycling reactions. Irreversible capacity is about 30 to 40 mAh/g for type D and E cells, whereas it is about 20 mAh/g for type F and G cells.

### c) Effect of the Electrolyte on the Cycling Lifetime of Lithium-Ion Cells:

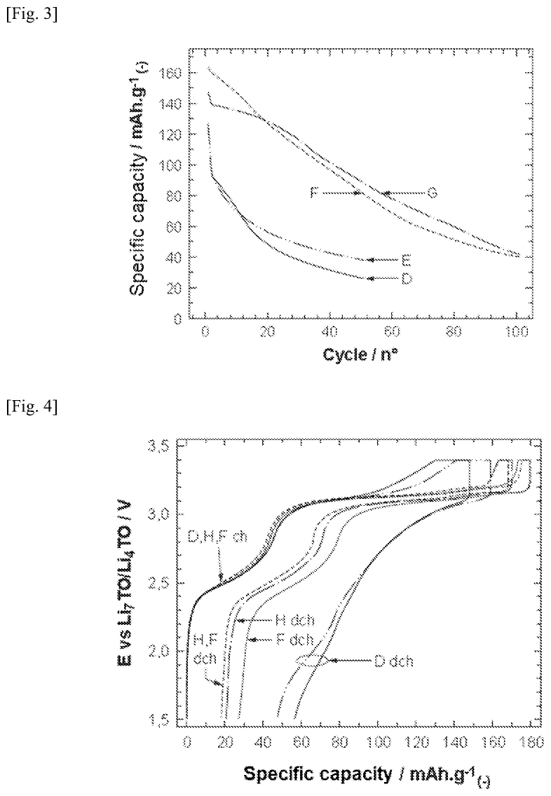

Cells D to G were next subjected to cycling at 45° C. at C/5 charge and discharge rate. FIG. 3 illustrates the variation in specific capacity per gram of active anodic material of these cells as a function of the number of cycles performed. It is ascertained right at the start of cycling that cells F and G comprising the gel-type electrolyte of the invention display much greater capacity than cells D and E comprising a liquid electrolyte. In addition, it is noted that cells F and G show a much slower decrease in capacity than cells D and E.

### d) Effect of P(VdF-HFP) Content in the Gel-Type Electrolyte on Irreversible Capacity and Reversible Capacity of the Cells:

Cells of type D, F H were subjected to an impregnation phase of their electrodes with the electrolyte for 12 hours at 60° C., the electrolyte either being in liquid form (cells D), or in gelled P(VdF-HFP)-based form (cells F and H). The cells were then subjected to «formation»with charge at C/10 rate followed by discharge at C/10 rate, C being the nominal capacity of the cells. The charge/discharge curves are given in FIG. 4. The use of the gel-type electrolyte of the invention allows a signification decrease in irreversible capacity at the first cycle. This is about 40 mAh/g(−), 20 mAh/g(−) and 15 mAh/g(−) for cells D, F and H respectively. The increase in P(VdF-HFP) content in the electrolyte by 10% (cells F) to 20% (cells H) allows irreversible capacity to be reduced at the first cycle.

e) Improvement in the Cycling Lifetime of a Cell Comprising a Gel-Type Electrolyte Containing 20% P(VdF-HFP) Compared with a Liquid Electrolyte:

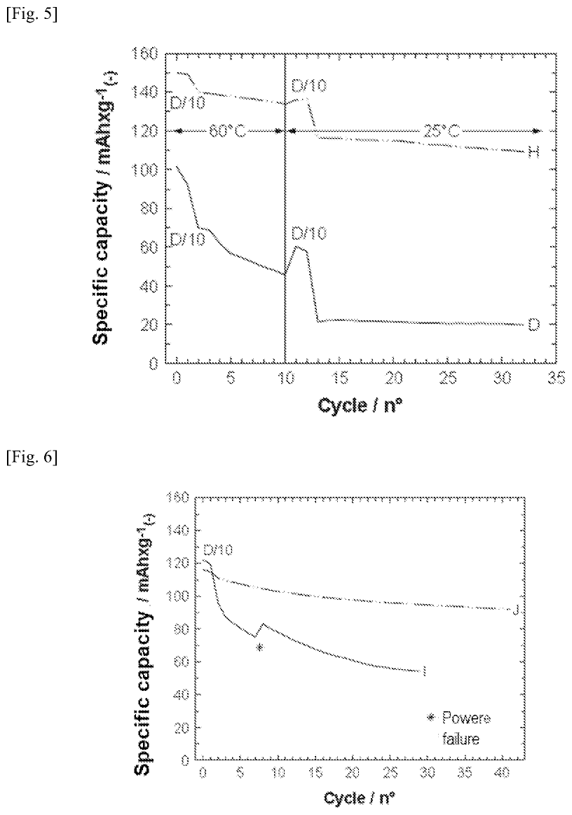

FIG. 5 illustrates the variation in specific capacity per gram of active anodic material for cells D and H during cycling comprising a first series of 10 cycles performed at a temperature of 60° C. followed by a second series of 22 cycles performed at a temperature of 25° C. Each cycle was composed of a charge at C/5 rate followed by discharge at C/5 rate. Two discharges at C/10 rate were performed at the start of the first series of 10 cycles, and at the start of the second series of 22 cycles. It is ascertained that right at the start of cycling, cell H comprising the gel-type electrolyte of the invention shows distinctly greater capacity that cell D comprising a liquid electrolyte. It is additionally noted that during the first series of cycles performed at 60° C., the capacity of cell H of the invention shows a much slower decrease than that of cell D. This demonstrates the benefit of using the gel-type electrolyte of the invention when cycling the cell at a temperature higher than ambient temperature.

A similar cycling test was conducted at 25° C. on cells with active cathodic material having the formula LiMn_{1.50}Ni_{0.5}O₄ instead of LiMn_{1.55}Ni_{0.41}Al_{0.04}O₄. These were cells I and J. These cells underwent formation at 25° C. composed of two charge/discharge cycles at C/10 rate. Formation was followed by cycling at 25° C. consisting of charges/discharges at C/5 rate.

FIG. 6 illustrates the variation in specific capacity per gram of active anodic material of cells I and J during this cycling. It is noted that the capacity of cell J of the invention decreases much more slowly than that of cell I which contains a liquid electrolyte. This confirms that the use of a gel-type electrolyte containing P(VdF-HFP) in association with a linear carbonate allows cycling stability of the cell at 25° C. to be increased, compared with a cell comprising a liquid electrolyte.

f) Impact of lithium Salt Concentration on Cell Capacity:

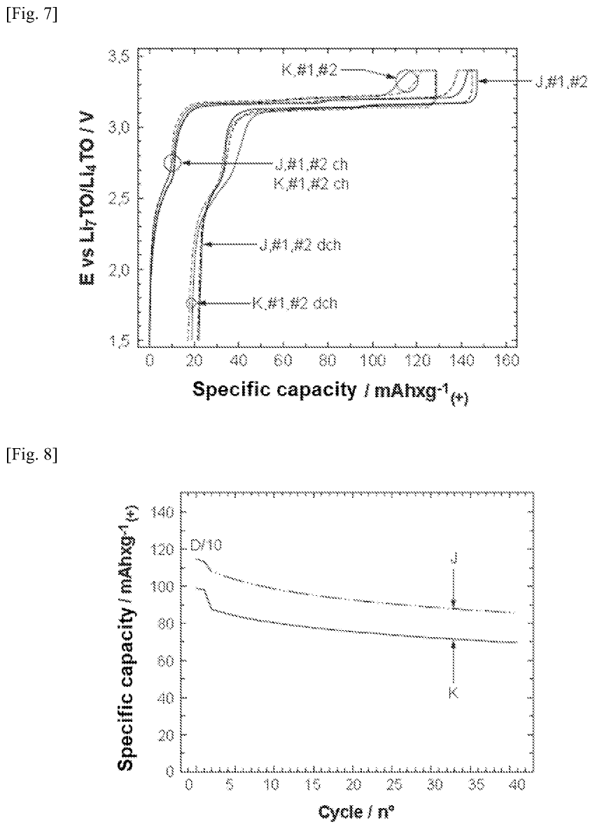

The performance of type J and K cells of the invention were compared. Two cells of type J contained LiPF₆ at a concentration of 1 mol·L⁻¹. Two cells of type K contained LiPF₆ at a concentration of 0.7 mol·L⁻¹. After an impregnation phase of the electrodes with the gel-type electrolyte for a time of 6 hours at a temperature of 60° C., the voltage variation curves of these cells during formation were recorded. They are given in FIG. 7. It is ascertained that the charge capacity of the type J cells containing LiPF₆ at a concentration of 1 mol·L⁻¹ is greater than that of type K cells containing LiPF₆ at a concentration of 0.7 mol·L⁻¹. The irreversible capacities are comparable.

The cycling performance of these two types of cells was evaluated during cycling at 25° C. under a charge/discharge rate of C/5. FIG. 8 illustrates the variation in specific capacity per gram of active cathodic material of type J and K cells during this cycling. The two first cycles comprised a discharge phase at C/10 rate. It is ascertained that right at the start of cycling, the discharge capacity of the type J cell containing LiPF₆ at a concentration of 1 mol·L⁻¹ is greater than that of the type K cell containing LiPF6 at a concentration of 0.7 mol·L⁻¹. This is a surprising result. It would be expected that a low concentration of lithium salt would increase the fluidity of the gel-type electrolyte, provide better soaking of the active cathodic or anodic material and improve performance of the cell. Yet, surprisingly, a larger capacity is charged and discharged when the lithium salt concentration is 1 mol·L⁻¹ than when this quantity is 0.7 mol·L⁻¹.

### g) Effect of the Solvent on Stability of the Gel-Type Electrolyte.

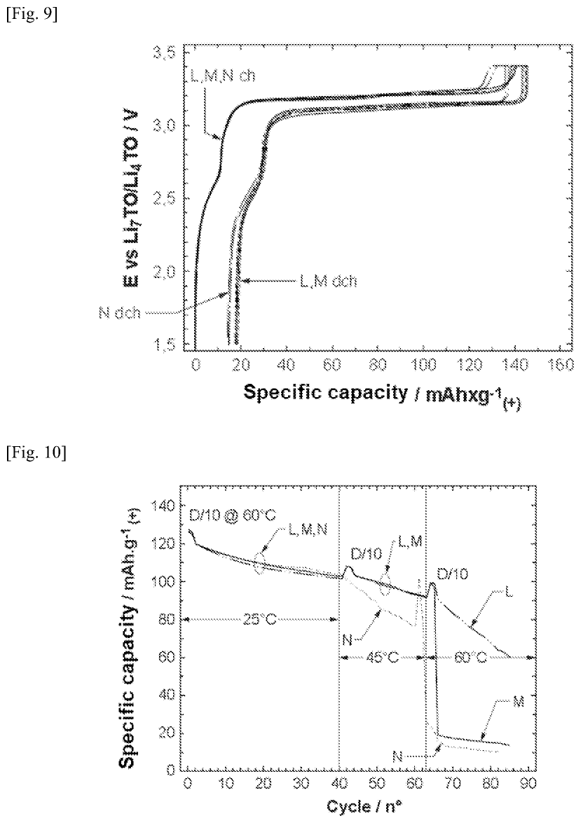

The effect of the type of carbonate used as solvent on the stability of the gel-type electrolyte was assessed by replacing part of the ethyl methyl carbonate EMC by a cyclic carbonate: ethylene carbonate EC. Cells of type L, M and N were prepared in which the electrolyte solvent contained 0%, 10% and 30% by volume respectively of EC. After an impregnation phase of the electrodes with the gel-type electrolyte for a time of 6 hours at a temperature of 60° C., the voltage variation curves of these cells during formation were plotted. They are given in FIG. 9. The charge capacity, discharge capacity and irreversible capacity of type L cells not containing EC are close to those of the type M cells containing 10% EC. It is also ascertained that the discharge capacity of the type N cells having an electrolyte solvent containing 30% EC is reduced compared with that of the cells of type L and M. Polarisation of type N cells is slightly increased. The increase in reactivity of the gel-type electrolyte in the type N cells can be accounted for by the increase in concentration of EC which is reactive with the cathode and anode.

The cycling performance of the cells of type L, M and N were then evaluated during cycling consisting of a first series of 40 cycles at 25° C., followed by a second series of 20 cycles at 45° C. and a third series of 25 cycles at 60° C., under a charge/discharge rate of C/5. FIG. 10 illustrates the variation in specific capacity per gram of active cathodic material of these cells during this cycling. The two first cycles of each series comprised a discharge phase at C/10 rate at 60° C. It is ascertained that during the first series of cycles at 25° C., the cycling performance of cells L, M and N is comparable with respect to discharge capacity. During the second series of cycles at 45° C., the drops in discharge capacity of the cells of type L and M in the solvent containing 0% et 10% EC respectively are similar. On the other hand, the drop in discharge capacity of the type N cell with a solvent containing 30% EC is distinctly faster than that of the cells of type L and M. During the third series of cycles at 60° C., the discharge capacities of type M and N cells are very low. The addition of ethylene carbonate does not appear to contribute any benefit with regard to cycling lifetime. On the contrary, it tends to react with the cathode and anode and to cause an increase in the impedance of the cell. Measurements of impedance taken after cycling of the cells indicate that the type N cell, with a solvent containing 30% EC, shows stronger impedance than the cells of type L and M. Increasing the temperature to 45° C. and 60° C. amplifies the instability of EC against the cathode and anode. To conclude, if one or more cyclic carbonates are contained in the electrolyte solvent, the volume percentage thereof is preferably less than 10%, even less than 5%.

It can be noted that all the electrolytes of the cells of type B-C, F-H, J-N according to the invention are free of additives such as VC. The presence of additives is not desirable since they are reactive, the reaction products could undergo cross-talk between the anode and cathode leading to degradation of the anode and cathode and to reduced lifetime of the cell.

1. A gel-type electrolyte comprising a matrix which is a poly(vinylidene fluoride-co-hexafluoropropylene) polymer (P(VdF-HFP)) in which is embedded a liquid mixture comprising at least one lithium salt and a solvent comprising at least one linear carbonate, the poly(vinylidene fluoride-co-hexafluoropropylene)(P(VdF-HFP)) polymer matrix representing 5 to 95% by weight relative to the weight of the gel-type electrolyte, the liquid mixture representing 95 to 5% by weight relative to the weight of the gel-type electrolyte.

2. The gel-type electrolyte according to claim 1, wherein the poly(vinylidene fluoride-co-hexafluoropropylene) polymer matrix represents 5 to 25% by weight of the weight of the gel-type electrolyte.

3. The gel-type electrolyte according to claim 1, wherein the solvent comprises ethyl methyl carbonate (EMC) and optionally another linear carbonate.

4. The gel-type electrolyte according to claim 1, wherein the solvent comprises dimethyl carbonate (DMC) and optionally another linear carbonate.

5. The gel-type electrolyte according to claim 1, wherein the solvent is composed solely of ethyl methyl carbonate (EMC) or is composed solely of dimethyl carbonate (DMC).

6. The gel-type electrolyte according to claim 1, wherein the solvent comprises at least one cyclic carbonate and the proportion of said at least one cyclic carbonate is less than or equal to 10%, preferably less than or equal to 5% by volume relative to the volume of the solvent.

7. The gel-type electrolyte according to claim 1, wherein the solvent does not comprise a cyclic carbonate.

8. The gel-type electrolyte according to claim 1, wherein the solvent comprises at least one non-fluorinated linear carbonate and at least one fluorinated linear carbonate.

9. The gel-type electrolyte according to claim 8, wherein said at least one fluorinated linear carbonate does not represent more than 30% by volume of the linear carbonates, preferably no more than 10%.

10. The gel-type electrolyte according to claim 1, wherein said at least one lithium salt is lithium hexafluorophosphate LiPF₆.

11. The gel-type electrolyte according to claim 10, wherein the contribution of lithium ions made by LiPF₆ represents at least 90% of the total quantity of lithium ions of the electrolyte.

12. An electrochemical cell comprising:
at least one cathode,
at least one anode,
the gel-type electrolyte according to claim 1.

13. The cell according to claim 12, wherein the cathode comprises an electrochemically active material able to operate at a voltage of at least 4.5 V versus the Li⁺/Li couple.

14. The cell according to claim 13, wherein the electrochemically active material able to operate at a voltage of at least 4.5 V versus the Li⁺/Li couple is selected from the group composed of:
a compound from group i) of formula LiNiₓM_{y}Mn_{2-x-y}O₄ with 0<x≤1; 0≤y≤0.1 where M is at least one element selected from among Fe, Co and Al;
a compound from group ii) of formula LiMn₁₋ₓMₓPO₄ with 0≤x≤1 where M is at least one element selected from among Ni, Co, Fe and Al;
a compound from group iii) of formula LiNi₁₋ₓMₓPO₄ with 0≤x≤1 where M is at least one element selected from among Fe, Co, Mn and Al;
a compound from group iv) of formula LiCo₁₋ₓMₓPO₄ with 0≤x≤1 where M is at least one element selected from among Fe, Ni, Mn and Al;
a compound from group v) of formula LiₓM_{1-y-z-w}M′_{y}M″_{z}M′″_{w}O₂ where M, M′, M″ and M′″ are selected from the group composed of B, Mg, Al, Si, Ca, Ti, V, Cr, Mn, Fe, Co, Ni, Cu, Zn, Y, Zr, Nb, W and Mo provided that at least M or M′ or M″ or M″' is selected from among Mn, Co, Ni or Fe; M, M′, M″ and M′″ differing from each other; and 0.8≤x≤1.4; 0≤y≤0.5; 0≤z≤0.5; 0≤w≤0.2 and x+y+z+w<2.1;
a compound from group vi) composed of the partially or fully disordered oxides and oxyfluorides of lithium and transition metals, of cubic structure, of formula Li₁₊ₓMO_{2-y}F_{y} where M is at least one element selected from the group composed of Na, K, Mg, Ca, B, Sc, Ti, V, Cr, Mn, Fe, Co, Ni, Cu, Zn, Al, Y, Zr, Nb, Mo, Ru, Ag, Sn, Sb, Ta, W, Bi, La, Pr, Eu, Nd and Sm and where 0≤x≤0.5 and 0≤y≤1; and
a mixture of several compounds selected from among groups i) to vi).

15. The cell according to claim 12, wherein the anode comprises an electrochemically active material operating at a potential of about 1.5 V versus the Li⁺/Li couple.

16. The cell according to claim 15, wherein the electrochemically active material operating at a potential of about 1.5 V versus the Li⁺/Li couple is selected from the group composed of:
a compound from group a) of formula Liₓ₋ₐMₐTi_{y-b}M′_{b}O_{4-c-d}X_{c} where 0<x≤3; 1≤y≤2.5; 0≤a≤1; 0≤b≤; 0≤c≤2 and −2.5≤d≤2.5;
M is at least one element selected from the group composed of Na, K, Mg, Ca, B, Mn, Fe, Co, Cr, Ni, Al, Cu, Ag, Pr, Y and La;
M′ is at least one element selected from the group composed of B, Mo, Mn, Ce, Sn, Zr, Si, W, V, Ta, Sb, Nb, Ru, Ag, Fe, Co, Ni, Zn, Al, Cr, La, Pr, Bi, Sc, Eu, Sm, Gd, Ti, Ce, Y and Eu;
X is at least one element selected from the group composed of S, F, Cl and Br;
such as the compounds Li_{4/3}Ti_{5/3}O₄ (Li₄Ti₅O₁₂), Li_{8/3}Ti_{4/3}O₄(Li₂TiO₃), Li_{8/7}Ti_{12/7}O₄ (Li₂Ti₃O₇), LiTi₂O₄, LiₓTi₂O₄ with 0<x≤2 and Li_{4/7}Na_{4/7}Ti_{12/7}O₄ (Li₂Na₂Ti₆O₁₄);
a compound from group b) of formula HₓTi_{y}O₄ where 0≤x≤1; 0<y≤2, such as H_{8/13}Ti_{24/13}O₄ (H₂Ti₆O₁₃), H_{8/25}Ti48/25O₄ (H₂Ti₁₂O₂₅) and Ti₂O₄(TiO₂);
a compound from group c) of formula LiₓTi_{a-y}M_{y}Nb_{b-z}M′_{z}O_{((x+4a+5b)/2)-c-d}X_{c} where 0≤x≤5; 0≤y≤1; 0≤z≤2; 1≤a≤5; 1b≤25; 0.25≤a/b≤2; 0≤c≤2 and 0≤d≤2; a−y>0; b−z>0;
d representing an oxygen vacancy,
M and M′ each being at least one element selected from the group composed of Li, Na, K, Mg, Ca, B, Sc, Ti, V, Cr, Mn, Fe, Co, Ni, Cu, Zn, Al, Y, Zr, Nb, Mo, Ru, Ag, Sn, Sb, Ta, W, Bi, La, Pr, Eu, Nd and Sm;
X is at least one element selected from the group composed of S, F, Cl and Br, such as TiNb₂O₇, Ti₂Nb₂O₉ and Ti₂Nb₁₀O₂₉;
d) a mixture of several compounds from groups a) to c).

17. The cell according to claim 12, wherein:
the electrochemically active material of the cathode has the formula LiNiₓM_{y}Mn_{2-x-y}O₄ with 0<x≤1, 0≤y≤0.1 where M is at least one element selected from among Fe, Co and Al;
the electrochemically active material of the anode has the formula Liₓ₋ₐMₐTi_{y-b}M′_{b}O_{4-c-d}X_{c}, where 0.5≤x≤3; 1≤y≤2.5; a=0; b=0; c=0 and d=0;
the liquid mixture comprises lithium hexafluorophosphate LiPF₆ and ethyl methyl carbonate (EMC) as solvent.
